(19) United States
(12) Patent Application Publication
(10) Pub. No.: US 2018/0064299 A1
(43) Pub. Date: Mar. 8, 2018

(54) SYSTEM FOR CLEANING LAVATORY PLUMBING FIXTURES AND RELATED METHOD

(71) Applicant: Rhett Searle, Fallbrook, CA (US)

(72) Inventor: Rhett Searle, Fallbrook, CA (US)

(21) Appl. No.: 15/256,601

(22) Filed: Sep. 4, 2016

(51) Int. Cl. A47K 11/10; A46B 13/00; A46B 13/02; B08B 1/00; B08B 1/04

(52) U.S. Cl. CPC A47K 11/10; A46B 13/001; B08B 1/04; B08B 1/002; A46B 13/02

(57) ABSTRACT

The disclosure concerns a system for cleaning lavatory plumbing fixtures, an instrument forming part of the system for cleaning lavatory plumbing fixtures, and a method for utilizing the system and instrument for cleaning lavatory plumbing fixtures. The instrument generally includes a shaft and a brush head configured to couple with the shaft. In certain embodiments, a rotary device is provided; the rotary device is coupled to the instrument for supplying power rotation for enhanced cleaning.

### BACKGROUND

### Field of the Invention

This invention relates to systems implementing cleaning instruments and related methods for cleaning lavatory plumbing fixtures such as toilets and sinks; and more particularly, to a rotary device and brush attachment configured for high speed rotary motion, and methods for cleaning lavatory plumbing fixtures by way of using the rotary device and attached brush.

### Description of the Related Art

Nearly every commercial and residential dwelling is equipped with at least one lavatory (also known as a “restroom”). For purposes herein, a lavatory is defined as a room or compartment with a toilet and washbasin (or “sink”).

For many years, cleaning the lavatory has been a daunting task for home and business owners and other occupants.

There is a need for more efficient or otherwise improved instruments for cleaning lavatory plumbing fixtures, such as toilets and sinks. Moreover, there is a need for improved methods for using such instruments to clean such lavatory plumbing fixtures.

### SUMMARY

The disclosure concerns a system for cleaning lavatory plumbing fixtures, an instrument forming part of the system for cleaning lavatory plumbing fixtures, and a method for utilizing the system and instrument for cleaning lavatory plumbing fixtures. The instrument generally includes a shaft and a brush head configured to couple with the shaft. In certain embodiments, a rotary device is provided; the rotary device is coupled to the instrument for supplying power rotation for enhanced cleaning.

### BRIEF DESCRIPTION OF THE DRAWINGS

FIG. 1 shows a perspective view of an instrument for cleaning lavatory plumbing fixtures.

FIG. 2 shows a side view of the instrument according to FIG. 1.

FIG. 3 shows a brush head configured to engage a shaft to form the instrument in accordance with one embodiment.

FIG. 4 shows a brush head configured to engage a shaft to form the instrument in accordance with another embodiment.

FIG. 5 shows a brush head configured to engage a shaft to form the instrument in accordance with yet another embodiment.

FIG. 6 shows a system including a rotary device and an instrument for cleaning lavatory plumbing fixtures.

FIG. 7 illustrates a method for cleaning lavatory plumbing fixtures.

### DETAILED DESCRIPTION OF THE PREFERRED EMBODIMENTS

For purposes of explanation and not limitation, details and descriptions of certain preferred embodiments are hereinafter provided such that one having ordinary skill in the art may be enabled to make and use the invention. These details and descriptions are representative only of certain preferred embodiments, however, and a myriad of other embodiments which will not be expressly described will be readily obvious to those of skill in the art upon a thorough review hereof. Accordingly, any reviewer of the instant disclosure should interpret the scope of the invention by the claims, and such scope shall not be limited by the embodiments disclosed herein.

For purposes of this disclosure, the term “lavatory plumbing fixture” includes a toilet or a washbasin (or “sink”).

The term “rotary device” means a power-assisted machine configured to produce a rotary motion, and includes a power drill or similar device.

The term “shaft” means an elongated, narrow part or section forming the body of a tool, or a similar implement.

The term “brush head” means an implement consisting essentially of bristles, hair, or wire set into a core, used for cleaning or scrubbing, applying a liquid or powder to a surface, or other purposes.

The term “polygonal” means including at least three straight sides and interior angles therebetween, wherein if the number of straight sides is “n”, then the sum of the interior angles is equal to (n−2)*180.

Now turning to the drawings, FIG. 1 shows a perspective view of an instrument 100 for cleaning lavatory plumbing fixtures. The instrument comprises a shaft 110 having a length (L) associated therewith, the length extends from a proximal end (P′) to a distal end (D′). The shaft further comprises a polygonal cross section 115 taken at one or more positions along the length of the shaft. The instrument further comprises a brush head 120, the brush head being configured to couple with the shaft at the distal end. A rotary device (See FIG. 6, 200) is configured to engage the shaft at the proximal end thereof and further configured to implement a rotary motion for rotating the brush head.

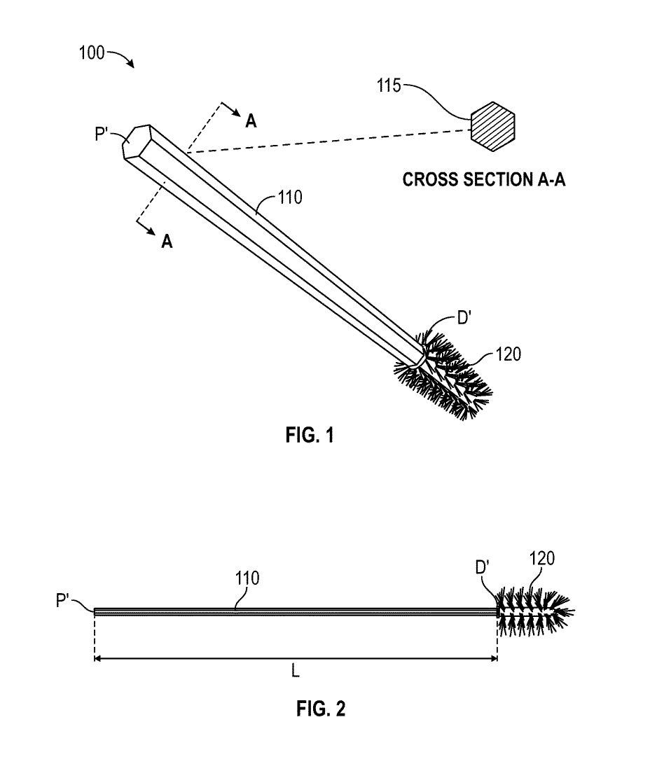

FIG. 2 shows a side view of the instrument according to FIG. 1. Here, the length (L) of the shaft 110 is further illustrated, which in a preferred embodiment the length may comprise between fifteen inches and thirty inches, and more preferably twenty one inches. While certain preferred lengths are disclosed, the shaft can be similarly configured with any length greater than those disclosed. The brush head 120 is shown coupled to the shaft at the distal end (D′) thereof.

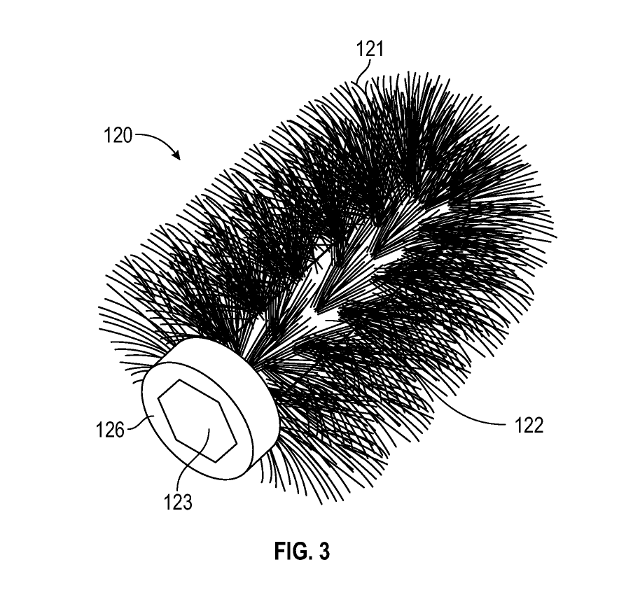

FIG. 3 shows a brush head 120 configured to engage a shaft 110 to form the instrument in accordance with one embodiment. The brush head comprises a core 122 and a plurality of bristles 121 extending radially outwardly from the core. Here, the brush head comprises a polygonal socket 123 having three or more walls collectively forming a circumference of the polygonal socket. The polygonal socket has the same number of sides as the shaft, and is configured to engage and nest with at least a portion of the shaft at the distal end (D′) thereof. For example, the distal end of the shaft is configured to enter a volume within the polygonal socket of the brush head and nest therein.

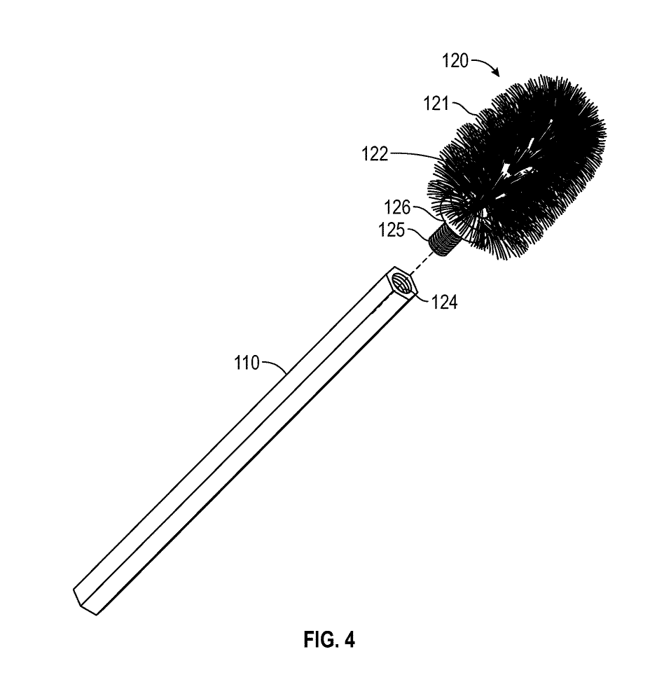

FIG. 4 shows a brush head 120 configured to engage a shaft 110 to form the instrument in accordance with another embodiment. Here, the shaft comprises a tapped hole 124 disposed at the distal end of the shaft, and the brush head comprises a threaded member 125 extending therefrom, wherein the threaded member is configured to engage the tapped hole of the shaft. In some embodiments, the threaded member and tapped hole may each comprise a reverse thread, for example where a standard thread would work itself loose.

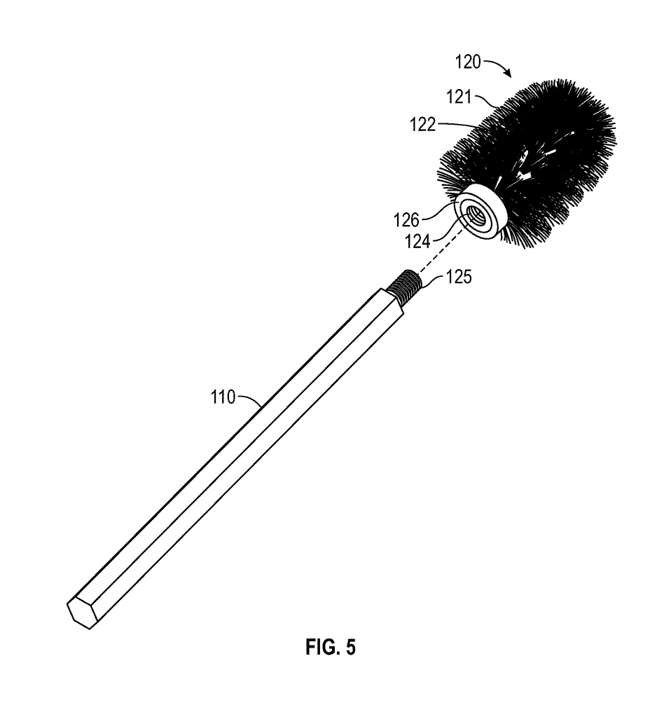

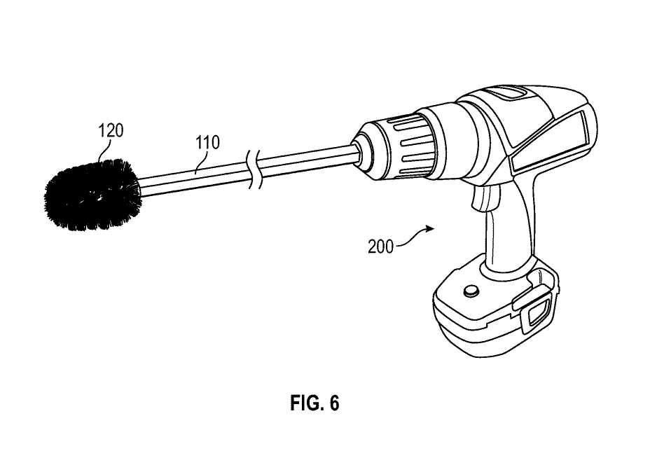

FIG. 5 shows a brush head 120 configured to engage a shaft 110 to form the instrument in accordance with yet another embodiment. Here, the brush head comprises a tapped hole 124, and the shaft comprises a threaded member 125 extending from the distal end thereof, wherein the threaded member is configured to engage the tapped hole of the brush head. In some embodiments, the threaded member and tapped hole may each comprise a reverse thread, for example where a standard thread would work itself loose.

FIG. 6 shows a system including a rotary device 200 and an instrument 100 for cleaning lavatory plumbing fixtures.

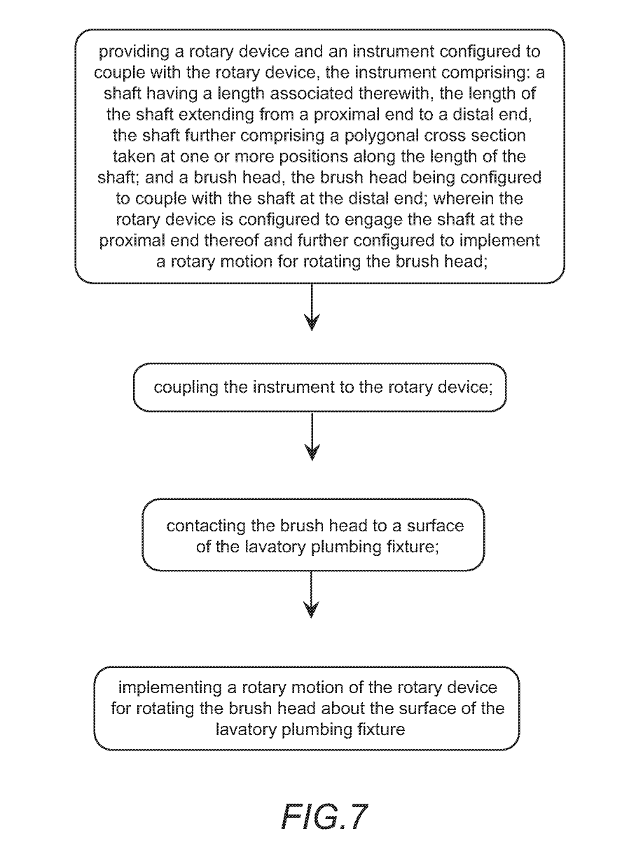

In another aspect, as illustrated in FIG. 7, a method for cleaning a lavatory plumbing fixtures comprises: (i) providing a rotary device and an instrument configured to couple with the rotary device, the instrument comprises: a shaft having a length associated therewith, the length of the shaft extending from a proximal end to a distal end, the shaft further comprising a polygonal cross section taken at one or more positions along the length of the shaft; and a brush head, the brush head being configured to couple with the shaft at the distal end; wherein the rotary device is configured to engage the shaft at the proximal end thereof and further configured to implement a rotary motion for rotating the brush head; (ii) coupling the instrument to the rotary device; (iii) contacting the brush head to a surface of the lavatory plumbing fixture; and (iv) implementing a rotary motion of the rotary device for rotating the brush head about the surface of the lavatory plumbing fixture.

Other features, embodiments and other variations of the above disclosure will be readily identifiable by those having skill in the art. While the instant disclosure provides detailed descriptions, such descriptions are not intended to limit the spirit and scope of the invention. Rather, the inventive scope shall only be determined through the claims as appended hereto.

### REFERENCE SIGNS

(D′) distal end
(P′) proximal end
(100) instrument
(110) shaft
(115) polygonal cross section
(120) brush head
(121) bristles
(122) core
(123) polygonal socket
(124) tapped hole
(125) threaded member
(126) flange
(200) rotary device

1. A system for cleaning lavatory plumbing fixtures, the system comprising:
a rotary device;
a shaft having a length associated therewith, the length extending from a proximal end to a distal end; and
a brush head, the brush head being configured to couple with the shaft at the distal end;
wherein the rotary device is configured to engage the shaft at the proximal end thereof and further configured to implement a rotary motion for rotating the shaft and the brush head.

2. The system of claim 1, said shaft including a polygonal cross section taken along the length of the shaft, said brush head comprising a polygonal socket having three or more walls collectively forming a circumference of the polygonal socket, wherein said polygonal socket is configured to engage at least a portion of the shaft at the distal end thereof.

3. The system of claim 1, said shaft comprising a tapped hole disposed at the distal end of the shaft, and said brush head comprising a threaded member extending therefrom, wherein the threaded member is configured to engage the tapped hole of the shaft.

4. The system of claim 1, said brush head comprising a tapped hole, and said shaft comprising a threaded member extending from the distal end thereof, wherein the threaded member is configured to engage the tapped hole of the brush head.

5. The system of claim 1, said brush head comprising a plurality of bristles extending radially outwardly from a core of the brush head.

6. The system of claim 1, wherein the length associated with the shaft is between fifteen inches and thirty inches.

7. An instrument for use with a rotary device in a system for cleaning lavatory plumbing fixtures, the instrument comprising:
a shaft having a length associated therewith, the length extending from a proximal end to a distal end; and
a brush head, the brush head being configured to couple with the shaft at the distal end;
wherein the rotary device is configured to engage the shaft at the proximal end thereof and further configured to implement a rotary motion for rotating the brush head.

8. The instrument of claim 7, said shaft including a polygonal cross section taken along the length of the shaft, said brush head comprising a polygonal socket having three or more walls collectively forming a circumference of the polygonal socket, wherein said polygonal socket is configured to engage at least a portion of the shaft at the distal end thereof.

9. The instrument of claim 7, said shaft comprising a tapped hole disposed at the distal end of the shaft, and said brush head comprising a threaded member extending therefrom, wherein the threaded member is configured to engage the tapped hole of the shaft.

10. The instrument of claim 7, said brush head comprising a tapped hole, and said shaft comprising a threaded member extending from the distal end thereof, wherein the threaded member is configured to engage the tapped hole of the brush head.

11. The instrument of claim 7, said brush head comprising a plurality of bristles extending radially outwardly from a core of the brush head.

12. The instrument of claim 7, wherein the length associated with the shaft is between fifteen inches and thirty inches.

13. A method for cleaning a lavatory plumbing fixture, the method comprising:
providing a rotary device and an instrument configured to couple with the rotary device, the instrument comprising:
a shaft having a length associated therewith, the length of the shaft extending from a proximal end to a distal end; and
a brush head, the brush head being configured to couple with the shaft at the distal end;
wherein the rotary device is configured to engage the shaft at the proximal end thereof and further configured to implement a rotary motion for rotating the brush head;
coupling the instrument to the rotary device;
contacting the brush head to a surface of the lavatory plumbing fixture; and
implementing a rotary motion of the rotary device for rotating the brush head about the surface of the lavatory plumbing fixture.

14. The method of claim 13, wherein the lavatory plumbing fixture comprises a toilet.

15. The method of claim 13, wherein the lavatory plumbing fixture comprises a sink.
